(19) United States
(12) Patent Application Publication
(10) Pub. No.: US 2007/0124184 A1
(43) Pub. Date: May 31, 2007

(54) Method for use of a customer experience business model to manage an organization by cross-functional processes from the perspective of customer experiences

(76) Inventors: Michael R. Schmit, Deephaven, MN (US); Jane Frances Lang, Minnetonka, MN (US); Robert Alex Russell, Port Huron, MI (US)

Correspondence Address: PERKINS COIE LLP/CARGILL, INC., P.O. BOX 1247, SEATTLE, WA, 98111-1247, US

(21) Appl. No.: 11/580,703

(22) Filed: Oct. 13, 2006

Related U.S. Application Data
(60) Provisional application No. 60/727,054, filed on Oct. 13, 2005.
(60) Provisional application No. 60/726,875, filed on Oct. 13, 2005.

(51) Int. Cl. G06F 9/44; G06F 17/50

(52) U.S. Cl. 705/7

(57) ABSTRACT

One embodiment of the present invention is a method of organizing a business to align goals of the business with goals of customers of the business and accelerate value creation for both the business and the customers of the business, the method comprising: identifying one or more experiences of customers of a business, wherein the one or more experiences are selected from the group consisting of the customers' value discovery experience, the customers' buying decision experience, the customers' ordering experience, the customers' receiving experience, the customers' using experience, the customers' payment experience, and the customers' feedback and problem resolution experience; organizing the business under a process management system for one or more of the customer experiences wherein each process management system comprises a process owner, a documenting process, formal process review, identification of customer driven measures and methods for process evaluation and improvement; gathering customer feedback regarding one or more of the customer experiences; and based on the customer feedback regarding one or more of the customer experiences, modifying the one or more process management systems associated with the customer experience to improve the one or more customer experiences.

### CROSS-REFERENCE TO RELATED APPLICATIONS

The present application claims priority to U.S. Provisional Application No. 60/727,054, filed Oct. 13, 2005, and U.S. Provisional Application No. 60/726,875, filed Oct. 13, 2005, the disclosures of both of which are incorporated by reference herein in their entirety.

### FIELD OF THE INVENTION

This invention relates to customer experience system map to manage an organization by cross-functional processes from the perspective of customer experiences.

### BACKGROUND OF THE INVENTION

Traditional business models have been functionally organized. Organization around functional groups such as sales, operations, or supply chains, often results in a vertical mentality whereby different function group are optimized from the perspective of the functional group without regard to the other functional groups of a business and/or the experience of customers of the business. Often, however, the experience of the customer may diverge from that of the specific functional group within the business.

Accordingly, there is a need in the art for methods to allow a business organization to be more closely aligned with customer needs and more readily able to adapt to customer experiences.

### SUMMARY OF THE INVENTION

One embodiment of the present invention is a method of organizing a business to align goals of the business with goals of customers of the business and accelerate value creation for both the business and the customers of the business, the method comprising: identifying one or more experiences of customers of a business, wherein the one or more experiences are selected from the group consisting of the customers' value discovery experience, the customers' buying decision experience, the customers' ordering experience, the customers' receiving experience, the customers' using experience, the customers' payment experience, and the customers' feedback and problem resolution experience; organizing the business under a process management system for one or more of the customer experiences wherein each process management system comprises a process owner, a documented process, formal process review, identification of customer driven measures and methods for process evaluation and improvement; gathering customer feedback regarding one or more of the customer experiences; and based on the customer feedback regarding one or more of the customer experiences, modifying the one or more process management systems associated with the customer experience to improve the one or more customer experiences.

Another embodiment of the present invention is a method of organizing a business in view of experiences of customers of said business, the method comprising: mapping at least one process within the business; based on said mapping of at least one process within the business, identifying one or more of why the process exists, where the process starts and stops, a sequence of steps in the process, customers of the process, and process outputs and inputs; mapping the at least one process within the business from a customer's point of view; based on said mapping of the at least one process within the business from the customer's point of view, identifying aspects of the at least one process that diverge from goals of the customer; and based on said identifying aspects of the at least one process that diverge from goals of the customer, organize the at least one process within the business such that the process is more aligned with the goals of the customer or creates additional value for the customer.

These and other aspects of the present invention are elucidated further in the detailed description.

### BRIEF DESCRIPTION OF THE DRAWINGS

FIG. 1 shows a map of a generic four-step process.

FIG. 2 shows a generic two-level sales process.

FIG. 3 shows the connection between the three main categories of business processes.

FIG. 4 shows a system map of Cargill Salt from the organization's viewpoint.

FIG. 5 shows a system map of Cargill Salt from the customer's viewpoint.

FIG. 6 shows a high level organizational chart according to an embodiment of the customer experience business model.

FIG. 7 shows a high level process organization chart is according to an embodiment of the customer experience business model.

FIG. 8 shows the senior leadership team of the process organization chart of FIG. 7.

FIG. 9 shows the transformation growth group of the process organization chart of FIG. 7.

FIG. 10 shows the enterprise planning group of the process organization chart of FIG. 7.

FIG. 11 shows the customer experience group of the process organization chart of FIG. 7.

FIG. 12 shows the customer fulfillment group of the process organization chart of FIG. 7.

FIG. 13 shows the operations knowledge group of the process organization chart of FIG. 7.

### DETAILED DESCRIPTION

The following description of the invention is intended to illustrate various embodiments of the invention. As such, the specific modifications discussed are not to be construed as limitations on the scope of the invention. It will be apparent to one skilled in the art that various equivalents, changes, and modifications may be made without departing from the scope of the invention, and it is understood that such equivalent embodiments are to be included herein.

In an embodiment of the present invention, a business model and a method to implement said business model is provided having a basis in a customer focused process management system and organizational structure. Said business model is referred to herein as a customer experience business model, which is aligned with experiences of customers of a business. Said model creates an agile organization that is focused on creating customer value, and through said model, customer value is created to a greater extent than through tradition vertical business models. A business organized according to the customer experience business model may include a process owner, documented process, formal process review, dashboard of customer driven measures and methods for process evaluation and improvement.

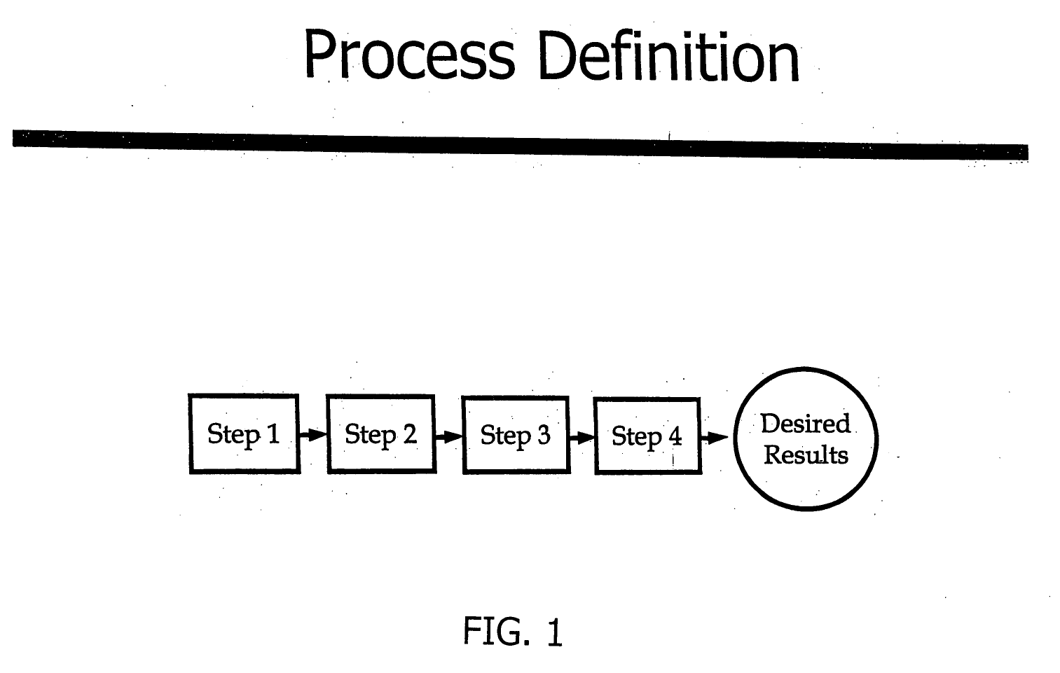

A process is a sequence of activities undertaken to achieve desired results. Referring to FIG. 1, a series of steps 1 to 4 are completed in succession to achieve the desired results. Examples of common processes in a business organization include but are not limited to: materials purchasing processes, lock-out processes, tag out processes, strategic planning processes, invoice processes, leadership development processes, customer acquisition processes, machine repair processes, product transport processes, quality incident processes, acquisition and integration processes, strategic pricing processes, performance management processes (PMP), and proposal processes.

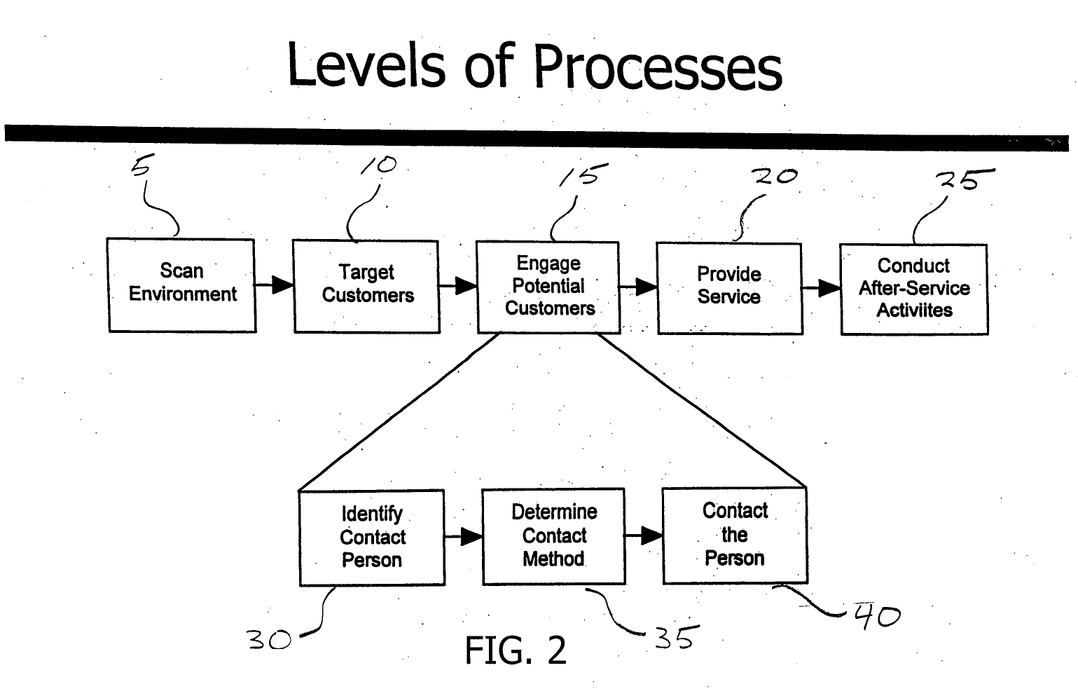

A process may be illustrated through a process map. Referring to FIG. 2, a generic sales process is shown comprising a first set of steps including scan environment 5, target customers 10, engage potential customers 15, provide the service 20, and conduct after service activities 25. The step of engaging potential customers 15 includes the substeps of identify contact person 30, determine contact method 35, contact the person 40, wherein the substeps are illustrated on a different level from the first set of steps 5 to 25.

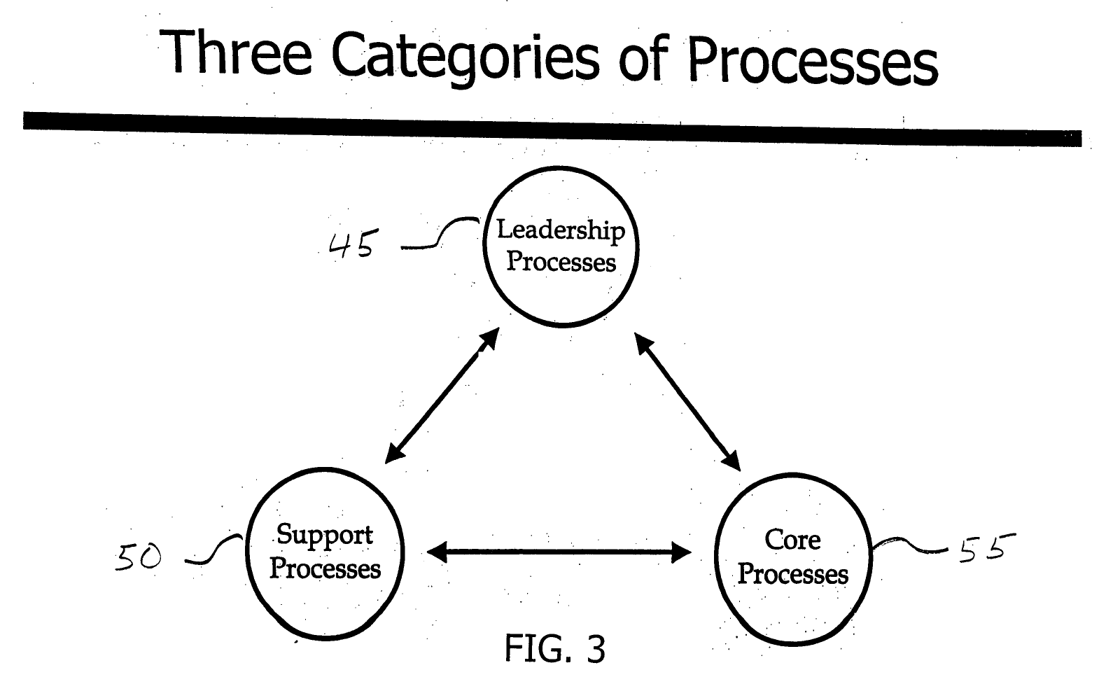

Referring to FIG. 3, in an aspect of the present embodiment, there may be three categories of business processes, including leadership processes 45, support processes 50 and core processes 55, which are all interconnected.

Because most work in organizations is conducted in the form of processes, customers experience most of these processes either directly or indirectly. The processes may range from very informal to formal and highly standardized. Often it is possible to improve overall results or experiences of a customer by improving individual processes within an organization. To this end, the implementation of a process management system ensures that cooperation and collaboration occurs between different process groups, managers and others within an organization that influence and/or control processes within an organization.

By organizing through a process management system, one is able to determine many important parameters of a process that can then be evaluated to improve the process. Examples of parameters of a process that can be mapped and monitored include but is not limited to why the process exist, where the process starts and stops, the sequence of steps in the process, the customers of the process, the process outputs, who is involved in the process, who is responsible for the success of the process, who needs to participate in the process, how the process is performing, who should review the process, and the process inputs and who supplies the process inputs.

With a process management approach many aspects of a business organization are improved. For example, the organizational structure is vertical and horizontal as described herein, as opposed to simply vertical. The depiction of the organization may be through a system map, as opposed to an organizational chart. The performance measures are operational and strategic, as opposed to simply operational. Customers are served from a system wide perspective, as opposed to a departmental perspective. Day to day work is performed with a departmental and process focus, as opposed to simply a departmental focus. Processes are formalized and standardized as opposed to informal and unrecognized. Process roles and responsibilities are clear, as opposed to unclear. Improvement is prioritized and focused, as opposed to ad hoc. The use of process management can promote standardization across various processes within a business organization such that different groups sections or processes in the organization can be standardized.

In another aspect of the present invention, a business organization organized under the process management approach may include a senior leadership team, which includes senior managers and a process champion. The senior managers are responsible for reviewing process performance. The process champion, as a member of the senior leadership team, is responsible for the strategic direction and performance of the process and will ensure that appropriate resources are available for success. The process owner is a mid level manager that is responsible for the day-to-day management of the process and monitors process performance, leads cross-functional permanent process team and regular process reviews, facilitates the resolution of cross-functional issues and leads process evaluation and improvement efforts. The process team members represent the view of the function or process in working through cross-functional issues with the process team and communicating said issues back rest of the team. In this regard, the process team members also monitor process performance, participate in cross-functional reviews, and participate in process evaluation and improvement efforts.

In another aspect of the present embodiment, the leadership team is responsible for developing, reviewing and improving the process management system. The process champion is responsible for the strategic direction and performance of the process. The process owner is responsible for the day to day management of the process. And the process team members are responsible for helping manage and improving the process.

In another aspect of the present embodiment, it is contemplated that some or all processes with a business organization may be managed through process management principles, while other groups within the business may be organized by function.

Review of processes with a process managed business is preferably ongoing. For example, a formal process review should be conducted periodically for each major process within a business organization. Process reviews may be conducted monthly or bimonthly and are attended by the process champion, process owner, and process team. During process review, the process is evaluated to identify areas for improvement and a process dashboard, a set of customer driven measurements for the process, is revised accordingly.

The typical agenda for process review may include issue recognition, action register review, review of the process dashboard and determination of improvement actions, discussion of potential issues, updating regarding ongoing improvement projects, and updating regarding the action register.

To aid in process analysis, it is often desirable to map processes or systems within a business organization. By identifying aspects of a system through a system map it is possible to understand the system on an organization-wide level. By representing the organization as a system one can identify the aim of the system, the components of the system, the interaction between components of the system, and then can optimize the system. Optimization may be based on various perspectives such as from the viewpoint of the organization itself or that of the organization's customers.

System maps allow one to identify process owners, create measures and improvement targets, improve or create cross-functional involvement, identify gaps between vertical lines and horizontal lines, screen new initiatives, establish priorities (budget, capital allocation), provide educational opportunities for customer service and other areas, provide developmental tools, and provide common vision for the organization.

Once a system map is developed, several methods may be utilized to improve processes and the system. Such methods usually begin with gathering of information regarding the process or system. Information may be gathered from many different sources. For example, information regarding aspects of a process may be gathered from emerging events, strategic planning, environmental scanning, performance dashboards, monthly reviews, project reviews, customer interfaces, employee interfaces, internal or external audits, regulatory changes, competitor moves, organizational assessments, or process characteristics.

Based on information gathered through these or other sources several different actions may be implemented. For example, an obvious action may be implemented immediately, a brainstorming session may take place to identify an improvement action and/or manage the improvement action's implementation, one may continue measurement of the performance measure, the process or process step may be standardized, the measurement of the particular information may be formalized, the process may be redesigned, the process may be flagged for further in depth study, or a formal team may be established to improve the process.

An example of an improvement method according to the present invention is to plan, do, study, and act. Planning may include defining the issue to establish the focus of the improvement, measuring the issue to determine the current status, and analyzing the issue to determine the causes of the issue and thus develop an action plan to address the issue. The next step is do, which includes determining an action that will address the issue by, for example, pilot programs, workshops or similar. The next step is study, which includes determining if the do step successfully addressed the issue by, for example, evaluation of the pilot program or analysis of feedback or data developed in the do step. The final step is to act, which includes controlling the changes to a process by, for example, standardizing the changes. All of the above steps may be ongoing at any time resulting in continual improvement of the process.

In another aspect of the present embodiment, the responsibilities of the management team may include to manage the enterprise improvement portfolio, identify enterprise improvement initiatives, assign roles and responsibilities, assure strong links to the organizational strategy, assure strong links to financials, conduct enterprise improvement system reviews, identify enterprise improvement system obstacles, and improve the enterprise improvement system.

Additional responsibilities of the process champion may include to review team progress, identify and remove barriers to progress, assure strong links to organizational strategy, communicate with executive management team, assure methodology and tools are being used, assure appropriate people are involved, assure team members are allowed to contribute, advise the team leader, help the team obtain resources, keep the team focused and transfer acquired knowledge.

### EXAMPLE I

An example according to the present invention, wherein the business organization is focused on creating customer value, is now described for use in a business organization, Cargill Salt. The primary goal of the present example is to align the goals of the business with the customers' experience thus accelerating growth for both the business and the customers of the business. In the present example the business is more agile and efficient, with the entire business organization focused on creating value for its customers in a more efficient manner.

In general, the present embodiment of the customer experience model is process focused instead of functionally focused, the model is aligned to maximize customer experiences and is a comprehensive enterprise strategy executed on an entire enterprise basis. The primary goal of the model is to consistently deliver positive customer experiences thus creating value for both the customer and the enterprise.

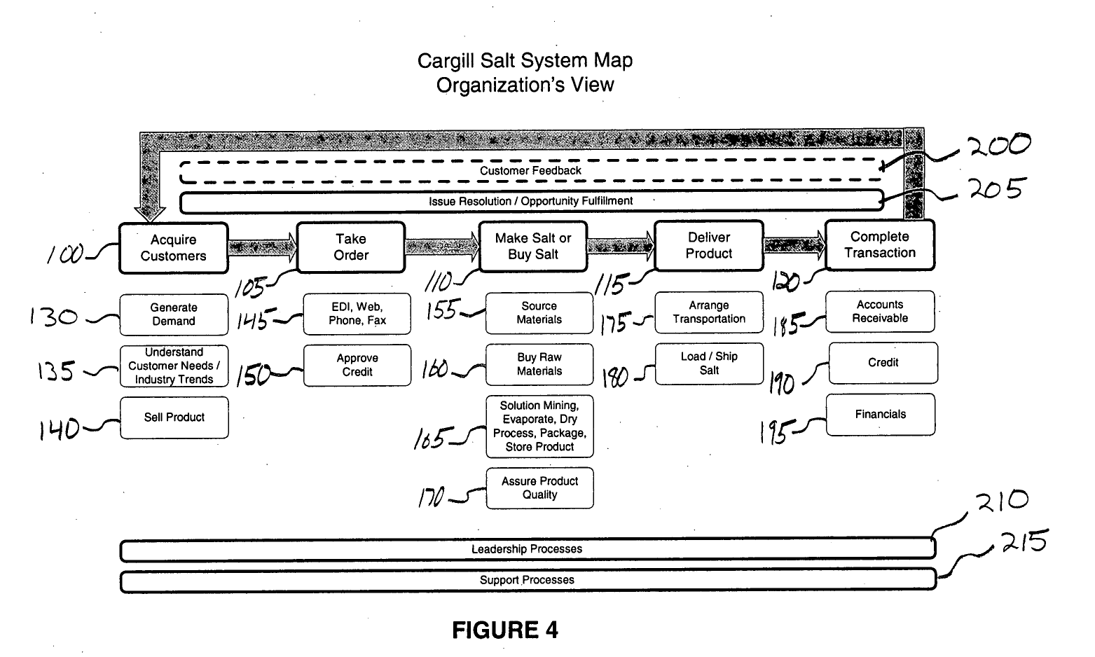

Referring to FIG. 4, a system map of Cargill Salt is shown from the business's viewpoint. In the system map of FIG. 4, five core processes are illustrated including acquire customers 100, take order 105, make or buy salt 110, deliver product 115, and complete transaction 120.

Several subprocesses are shown within each core process. For example, within acquire customers 100 are the subprocesses generate demand 130, understand client needs/industry trends 135 and sell product 140, within take order 105 are the subprocesses electronic data interchange (EDI), web, phone or fax 145 and approve credit 150, within make salt or buy salt 110 are the subprocesses source materials 155, buy raw materials 160, solution mining, evaporate, dry process, package, store product 165 and assure quality product 170, within deliver product 115 are the subprocesses arrange transport 175 and load/ship salt 180, and within complete transaction 120 are the subprocesses accounts receivable 185, credit 190 and financials 195.

Throughout the operation of the core processes 100 to 120, several other process are operating including customer feedback 200, issue resolution/opportunity feedback 205, leadership process 210 and support process 215.

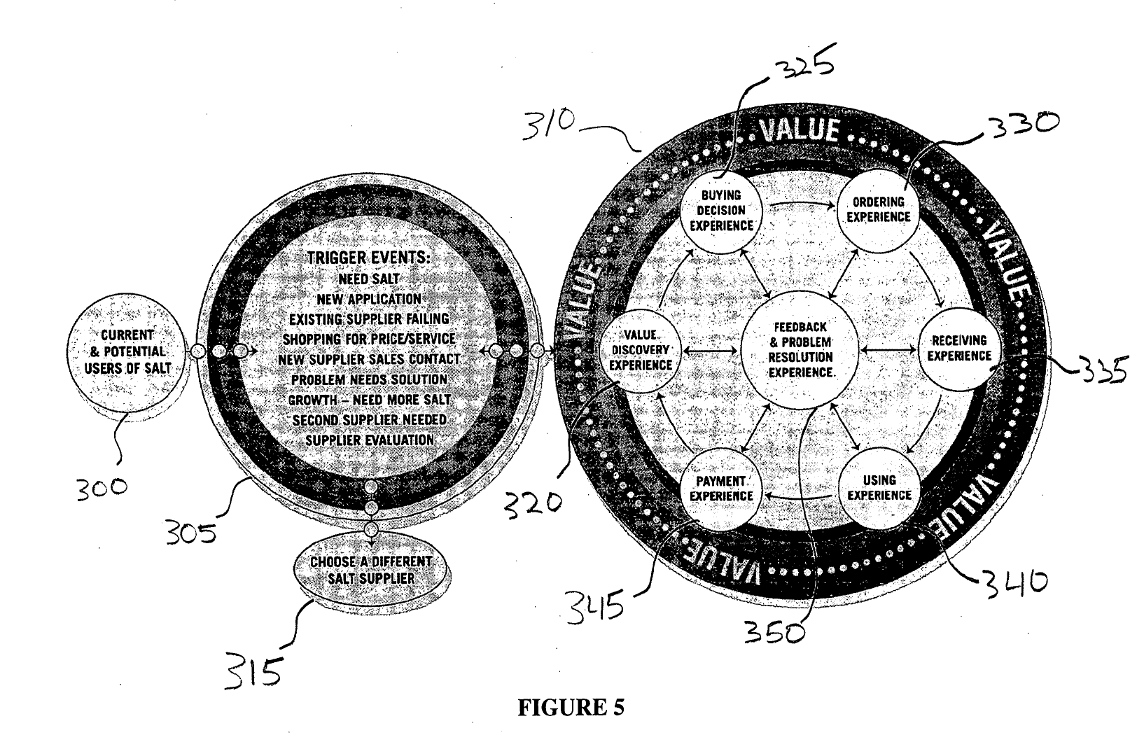

Referring to FIG. 5, a system map for the business of FIG. 4 is shown from the customer's viewpoint. The current or potential users of salt 300 encounter a triggering event 305 which may include one or more of the following that triggers a need for salt: new application for salt, existing supplier failure, shopping for a reduced price or better service, new supplier sales contact, problem needing a solution, growth and the need for more salt, a second supplier is needed and/or a supplier is being evaluated. As a result of the triggering event 305, the current or potential user of salt 300 may contact Cargill Salt 310, wherein Cargill Salt 310 is shown as the customer experiences Cargill Salt, and depending on Cargill Salt's response, the current or potential user of salt may select Cargill Salt 310 or another supplier 315 to address its needs.

The customer's experience of Cargill Salt 310 includes several types of experiences. For example, the customer may have a value discovery experience 320, a buying decision experience 325, an ordering experience 330, a receiving experience 335, a using experience 340, a payment experience 345 and/or a feedback and problem resolution experience 350 which may or may not include feedback and resolution regarding any of experiences 320 to 345.

FIGS. 4 and 5 are related in that FIG. 5 demonstrates the customer's viewpoint of the various processes set forth in FIG. 4.

While most business organizations have processes and procedures that are functionally driven, in said example the processes are customer driven. For example, many organizations include a credit group that is responsible for customer credit and collection processes. In most organizations these processes are functionally driven and focused internally on the needs of the business organization and even the specific department within the business organization. As such the processes are optimized to be the most efficient within the business organization. Employing the customer experience approach, and viewing the process from a customer perspective the processes may not always be optimized for the customer. Under the present embodiment of the customer experience business model, the most advantage is gained by optimizing the internal processes from the customer's perspective. Further in the present embodiment, the primary focus of the organization is to improve the customer experience.

In view of and based on the customer experience business model shown in FIG. 5, a high level process organizational chart may be implemented that may include one or more of the customer experiences 320 to 350 of FIG. 5.

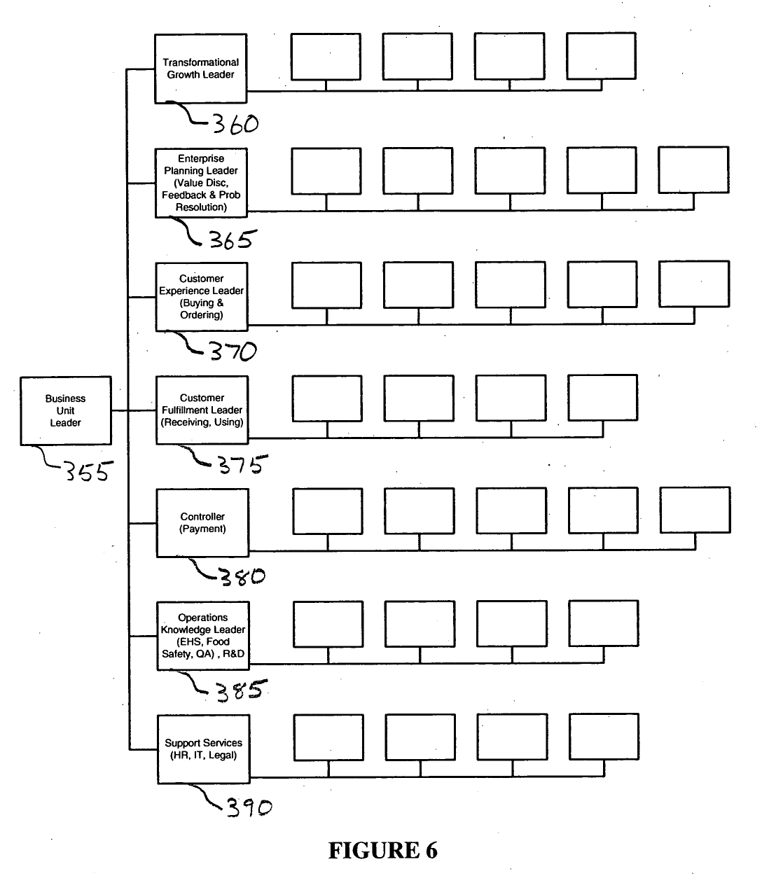

Referring to FIGS. 5 and 6, an organization chart is shown that includes and is based in part upon the customer experiences 320 to 350 of FIG. 5. The organizational chart of FIG. 6 includes a business unit leader 355, a transformational growth leader 360, an enterprise planning leader 365, a customer experience leader 370, a customer fulfillment leader 375, a controller 385, an operations knowledge leader 390, and support services 395. The enterprise planning group is responsible for managing the value discovery experience 320 and the feedback and problem resolution experience 350, the customer experience group is responsible for managing the buying experience 325 and ordering experience 330, the customer fulfillment group is responsible for managing the receiving experience 335 and the using experience 340, and the controller is responsible for managing the payment experience 345.

The remaining groups retain a functional organization and include the transformational growth group 360, the operations knowledge group 385 and support services group 390.

In another aspect of the present example, to retain the benefits of a strong functionally organized business, functional knowledge leaders may be used to ensure a strong functional skill set with each of the above process groups. Functional knowledge leaders manage talent pipeline, collaborate with corporate centers of expertise and function as the internal experts to the continually review business results and look for functional improvement opportunities.

In yet another aspect of the present embodiment, each individual or group may overlap in personnel with other processes or groups including the functional knowledge leaders. Further, in addition to the above, every individual in every group team or process set forth above is responsible for generating and communicating ideas that improve the customer's experience.

### EXAMPLE II

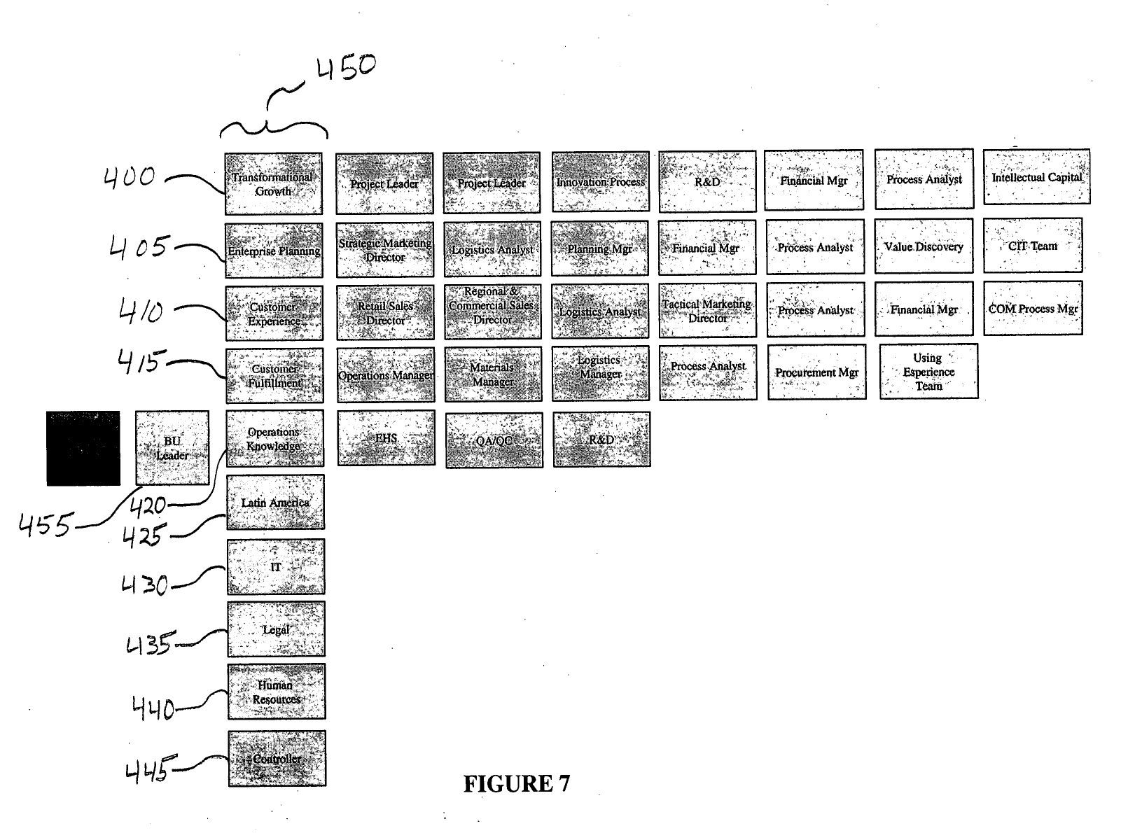

Referring to FIG. 7, in another example of the present invention, an organizational chart implementing and based on the customer experiences 320 to 350 of FIG. 5 is shown. The chart is laid out in a horizontal manner as opposed to vertically as in most business organizational charts. The horizontal display reflects that the organization is not hierarchical. The boxes of the chart do not necessarily represent peers or subordinates. In addition the boxes may represent individual, teams of individuals or entire groups of hundreds of employees. Column 450 and the business leader 455 represent the senior leadership team.

Referring to FIGS. 5 and 7, the enterprise planning group 405 may be responsible for the value discovery experience 320 and feedback and problem resolution experience 350, the customer experience group 410 may be responsible for the buying decision experience 325 and ordering experience 330, the customer fulfillment group may be responsible for the receiving experience 335 and the using experience 340, and the controller 445 may be responsible for the payment experience 345. In the alternative, it is contemplated that any group set forth in the senior leadership team of FIG. 6 may include one or more of the customer experiences 320 to 350 of FIG. 5.

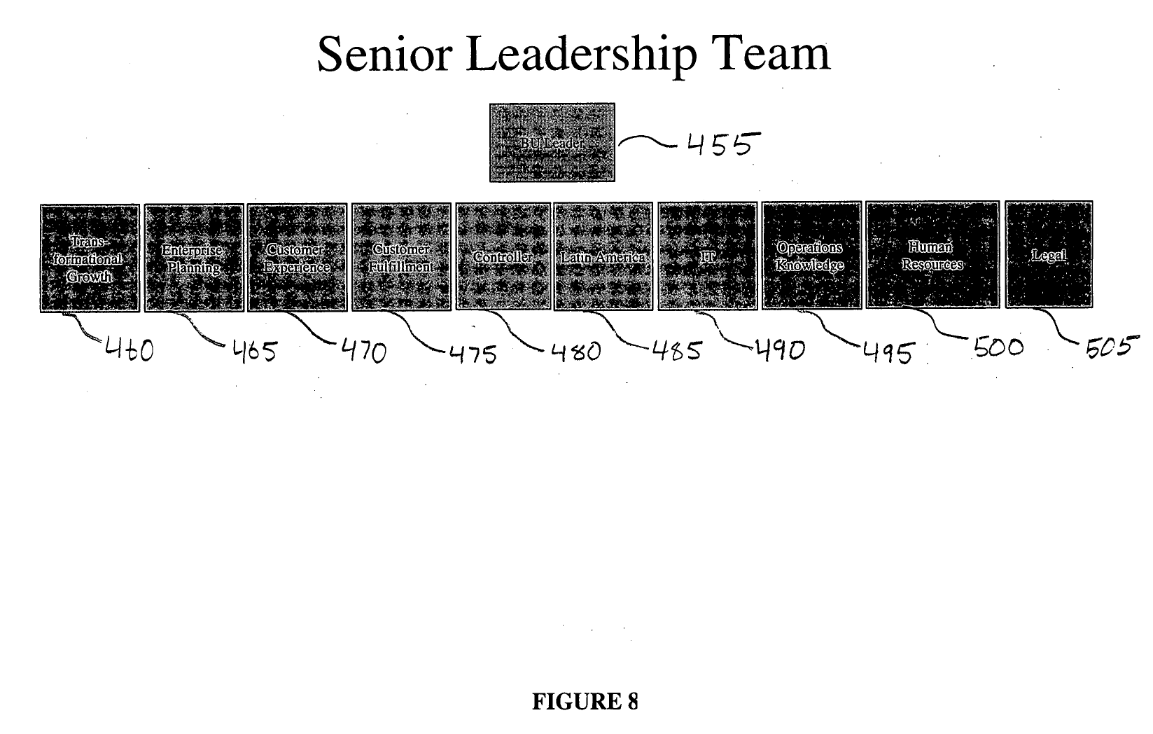

Referring to FIG. 8, the senior leadership team is responsible for the several processes including, talent and leadership development, compensation, and business model validation and improvement. Decision rights for the senior leadership team include approval of high level processes, strategy for the business organization, budgets, plans, and compensation and recognition programs.

The senior leadership team may include the following: the business leader 455 and reporting to the business leader 455, transformational growth 460, enterprise planning 465, customer experience 470, customer fulfillment 475, Controller 480, foreign operations (Latin America) 485, information technology (IT) 490, operations knowledge 495, human resources 500, and legal 505.

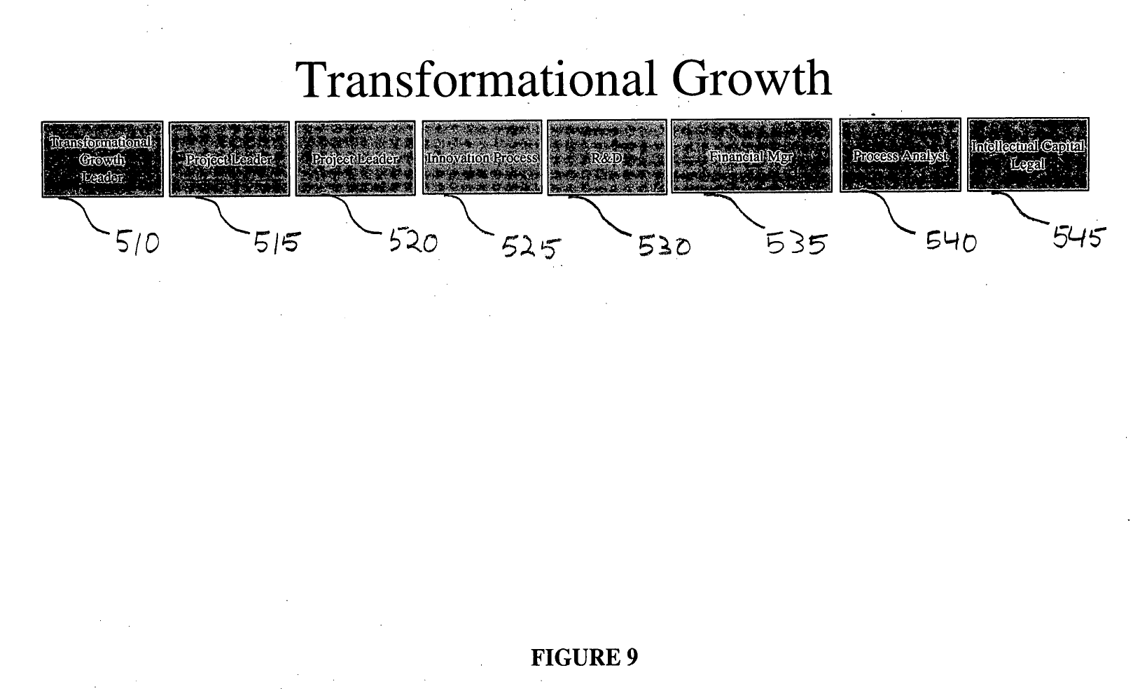

Referring to FIG. 9, the transformation growth group 460 is responsible for the several processes including idea management, intellectual property management, and decision rights include how to execute transformational growth projects. Decision rights of the transformation growth group 460 may include how to execute transformational growth projects.

The roles and responsibilities of the transformation growth group 460 are as follows: the transformational growth leader 510 is responsible for leading the team to accomplish goals including how, when and what tools to employ to accomplish transformation growth processes; the innovation lead 525 is responsible for idea management processes including rollout, implementation and training plan for idea management processes; the project managers 515 and 520 are responsible for management of assigned projects including how and when to complete projects and scouting for new opportunities and idea generation; the financial manager 535 is responsible for support of the financial needs of the team; intellectual capital legal 545, as a legal expert, is responsible for rollout, implementation and training for intellectual capital management; the research and development (R&D) lead 530 is responsible for insuring R&D transformational projects are completed as planned and support for other transformation project R&D needs; the process analyst group/knowledge leader 540, which includes law, human resources, quality assurance, R&D, and finance, is responsible for supplying people and knowledge resources for agreed upon transformational projects; the idea team (not shown) is responsible for idea management and review.

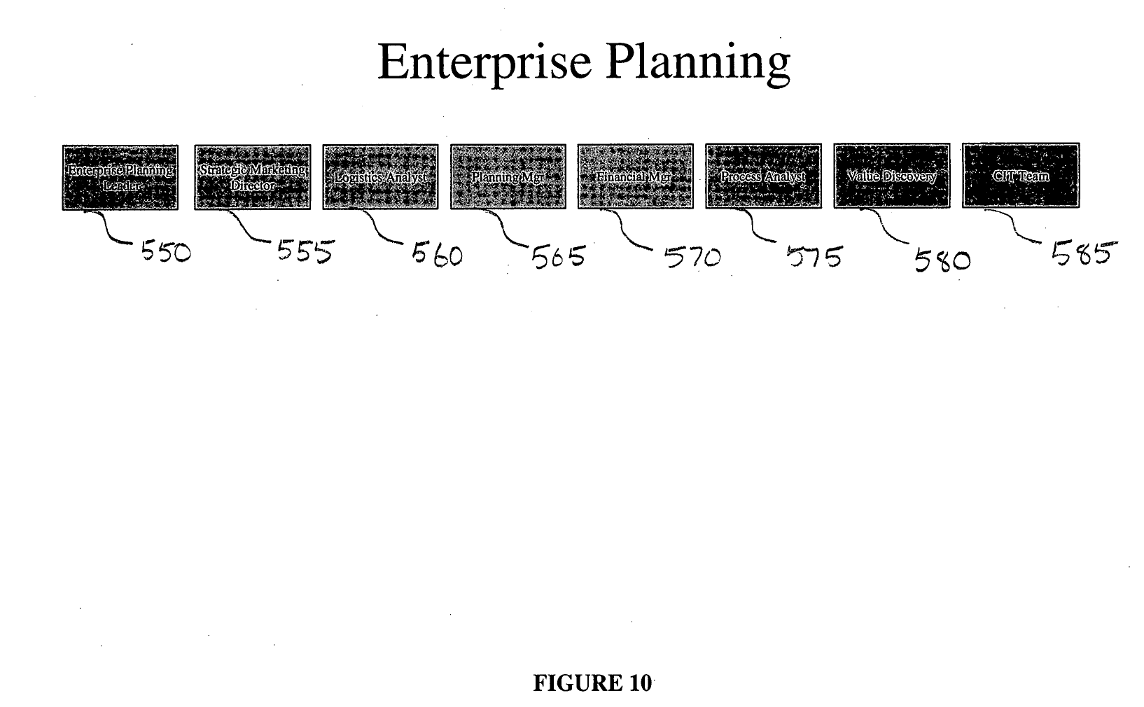

Referring to FIG. 10, the enterprise planning group 465 is responsible for the several processes including enterprise strategy development, budgeting, project portfolio management, value discovery experience, feedback and problem resolution experience, and reflects the voice of the customer. Decision rights of the enterprise planning group 465 include resource allocation processes and budgeting processes.

The roles and responsibilities of the enterprise planning group 465 include the following: the enterprise planning leader 550 is responsible for providing leadership and direction to develop and deploy business strategy regarding budgeting, people and capital project resources, project priority, strategic pricing, volumes and geographies; the senior marketing director 555 is responsible for high level leadership of marketing such as high level pricing decisions, volumes and geographies; the planning manager 565 is responsible for budgeting, people and capital management, volume targets, geographical targets, and product targets; the financial manger 570 is responsible for analysis of budgeting, capital deployment, high level pricing and financial targets; the process analyst 575 is responsible for the management of effectiveness of process integration points; the logistical analyst 560 is responsible for managing logistical costs, identification of trends and opportunities, communication of areas of risk and opportunities; the value discovery team 580 is responsible for leadership of discovery processes including value segments, customer value drivers, and acting as the voice of the customer; the continuous improvement team (CIT team) 585 is responsible for leading customer incident and tracking and resolution processes including maintaining SLA agreements, maintaining the customer improvement team database and root cause analysis. Some or all of the foregoing are responsible for monitoring and communicating trigger events and value opportunities including identifying significant changes in competition, supply and demand, financial performance, customer value drivers, technological changes, governmental regulations, customer satisfaction, and corporate requirements.

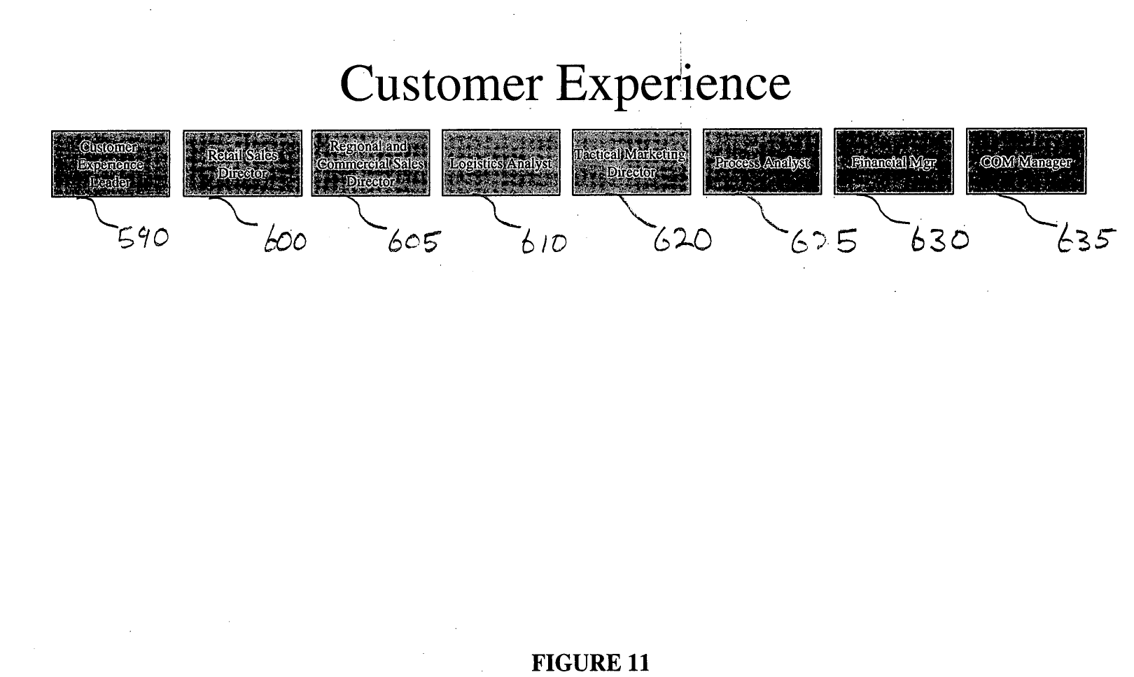

Referring to FIG. 11, the customer experience group 470 is responsible for the several processes including prospecting, account selection, value based selling, customer relationship management, credit approval, customer order management, new account set-up, and perfect order analysis. Decision rights of the customer experience group 470 include optimizing book of business to achieve enterprise objectives and developing sales, marketing and customer service tactics to support targeted accounts.

The roles and responsibilities of the customer experience group 470 are as follows: the customer experience leader 590 is responsible for leading the team to accomplish its goals such as ensuring value commitments are delivered to targeted accounts that generate required financial returns; the retail sales director 600 is responsible for leadership of grocery, foodservices and retail sales teams including selection of all accounts to optimize book of business in market segments, pricing and promotional programs and value discovery to meet enterprise objectives; the regional and commercial sales director 605 is responsible for leadership of the regional and commercial strategic account teams including selection of accounts to optimize book of business in market segments, pricing and promotional programs and value discovery to meet enterprise objectives; the tactical and marketing director 620 is responsible for leadership of the marketing team to provide promotional support and include development, deployment and promotional programs and marketing activities to meet targeted account value requirements; the customer order management (COM) manager 635 is responsible for leadership of customer service processes such as development and implementation of customer service processes to support value commitments to selected accounts; the logistics analyst 610 is responsible for identification of logistical opportunities and risks in meeting enterprise or account value expectations; the financial manager 630 is responsible for integrity and accuracy of financial analysis and decision support to insure financial returns; and the process analyst 625 is responsible for ensuring effectiveness of processes integration points and the effectiveness of process to deliver value to targeted customers and Cargill Salt.

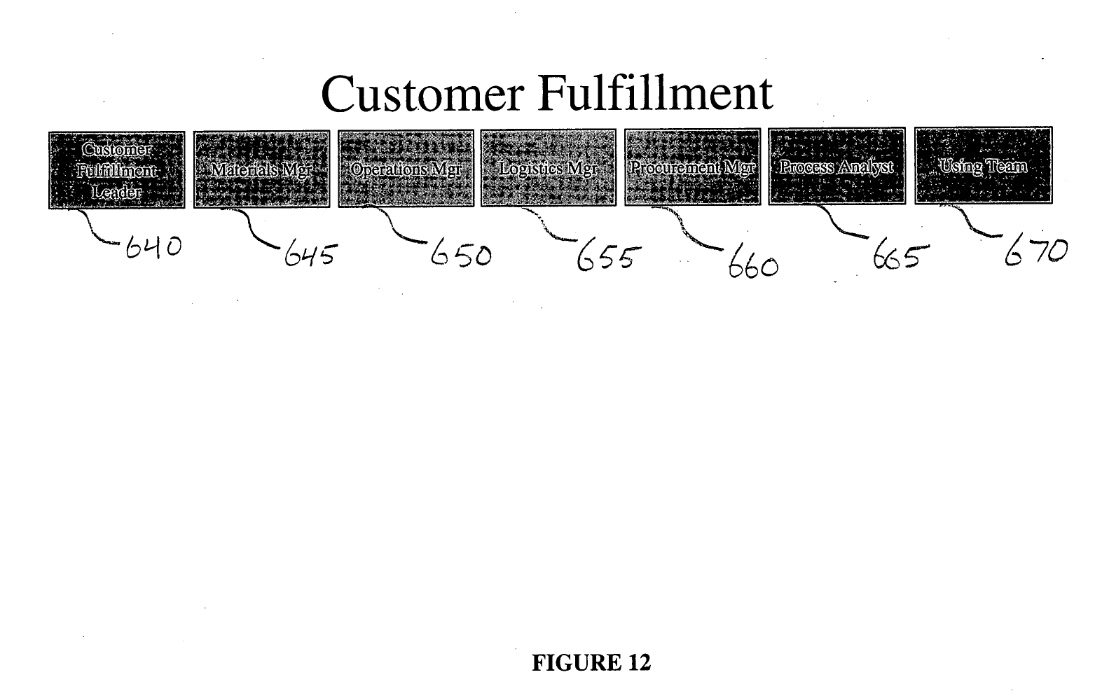

Referring to FIG. 12, the customer fulfillment group 475 is responsible for the several processes including, operations management, materials management, maintenance, procurement, operations and capital (MPOC), logistics management, using experience. Decision rights of the customer fulfillment group 475 include deployment of supply and demand plan, inventory and warehouse levels, carriers and suppliers.

The roles and responsibilities of the customer fulfillment group 475 are as follows: the customer fulfillment leader 640 is responsible for ensuring performance on value commitments; the materials manager 645 is responsible for leading the production control and inventory processes including optimizing inventory positions, achieving perfect order target and managing the advanced planning and scheduling processes; the operations manager 650 is responsible for leading the operations processes and team including achieving environmental health and safety (EHS) objectives, achieving product specifications and functionality requirements, producing to plan, and optimizing operational efficiencies; the logistics manager 655 is responsible for leading the transportation and distribution processes including managing carrier performance, optimizing distribution efficiencies and achieving perfect order target; the procurement manager 660 is responsible for leading the procurement processes including managing supplier performance and relationships, optimizing category costs, and achieving MPOC targets; the process analyst 665 is responsible for providing financial and process analysis including managing customer fulfillment dashboards, supporting functional dashboards and/or standards and goals (S&G's) and analyzing process and/or functional alternatives; the using team 670 is responsible for developing, implementing and achieving process flows, integration and metrics including optimizing customer using experience through alignment of processes and capabilities.

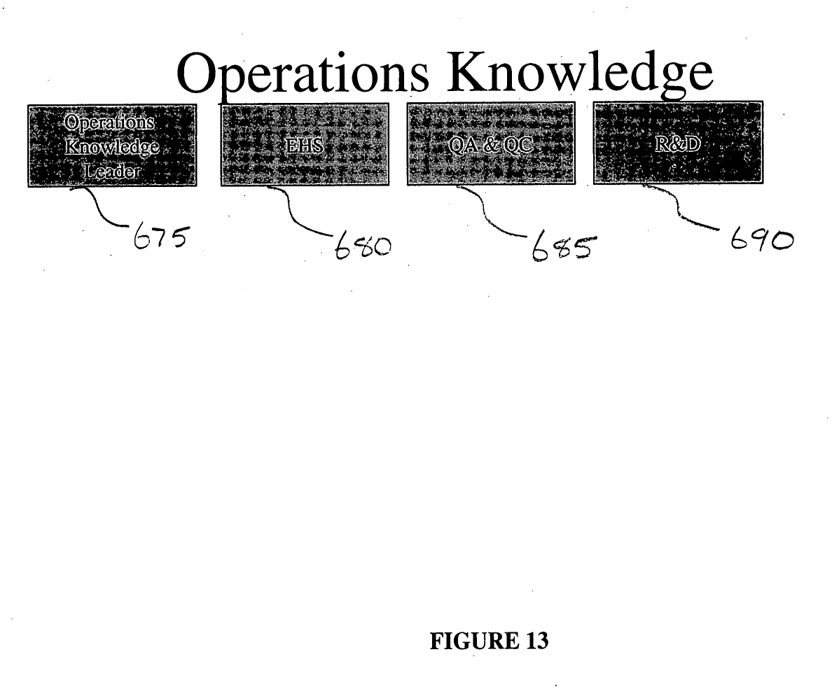

Referring to FIG. 13, the operations knowledge group 495 is responsible for the several processes including talent acquisition, benchmarking, operations training & education, corporate audit processes and standards on EHS, quality assurance and quality control (QA/QC), food and feed safety, and research and development project selection. Decision rights include staffing and operations training and education. It is contemplated that this group may be functional organized.

In another aspect of the present example, to retain the benefits of a strong functionally organized business, functional knowledge leaders may be used to ensure a strong functional skill set with each of the above process groups. Functional knowledge leaders manage talent pipeline, collaborate with corporate centers of expertise and function as the internal experts to the continually review business results and look for functional improvement opportunities.

In yet another aspect of the present example, each individual or group may overlap in personnel with other processes or groups including the functional knowledge leaders. Further, in addition to the above, every individual in every group team or process set forth above is responsible for generating and communicating ideas that improve the customer's experience.

As stated above, the foregoing is merely intended to illustrate various embodiments of the present invention. The specific modifications discussed above are not to be construed as limitations on the scope of the invention. It will be apparent to one skilled in the art that various equivalents, changes, and modifications may be made without departing from the scope of the invention, and it is understood that such equivalent embodiments are to be included herein. Therefore, it must be expressly understood that the illustrated embodiments have been shown only for the purposes of example and should not be taken as limiting the invention, which is defined by the following claims. All references cited herein are incorporated by reference as if fully set forth herein.

What is claimed is:

1. A method of organizing a business to align goals of the business with goals of customers of the business and accelerate value creation for both the business and the customers of the business, the method comprising:
identifying one or more experiences of customers of a business, wherein the one or more experiences are selected from the group consisting of the customers' value discovery experience, the customers' buying decision experience, the customers' ordering experience, the customers' receiving experience, the customers' using experience, the customers' payment experience, and the customers' feedback and problem resolution experience;
organizing the business under a process management system for one or more of the customer experiences identified, wherein each process management system comprises a process owner, a documenting process, formal process review, identification of customer driven measures and methods for process evaluation and improvement;
gathering customer feedback regarding one or more of the customer experiences; and
based on the customer feedback regarding one or more of the customer experiences, modifying the one or more process management systems associated with the customer experience to improve the one or more customer experiences.

2. The method of claim 1 wherein the step of gathering customer feedback is automated or semi-automated with an electronic system comprising a computer processor and at least one database.

3. The method of claim 2 wherein the customer feedback is automatically communicated to one or more of the process management systems via electronic communication.

4. The method of claim 1 wherein the modifications of one or more of the process management systems are automatically communication to the remaining process management systems via an electronic communication.

5. A method of organizing a business in view of experiences of customers of said business comprising the steps of:
mapping at least one process within the business; based on said mapping of at least one process within the business, identifying why the process exists, where the process starts and stops, a sequence of steps in the process, customers of the process, and process outputs and inputs, mapping the at least one process within the business from a customer's point of view;
based on said mapping of the at least one process within the business from the customers point of view, identifying aspects of the at least one process that diverge from goals of the customer; and
based on said identifying aspects of the at least one process that diverge from goals of the customer, organize the at least one process within the business organization such that the process is more aligned with the goals of the customer or creates additional value for the customer.

6. The method of claim 5 further comprising gathering customer feedback regarding one or more of the customer goals.

7. The method of claim 6 wherein the step of gathering customer feedback regarding one or more of the customer goals is automated or semi-automated with an electronic system comprising a computer processor and at least one database.

8. The method of claim 7 wherein the step of mapping at least one process within the business comprises identification of customer goals.

9. The method of claim 8 further comprising the step of automatically communication the customer goals to a process management team automatically or semi automatically via electronic communication.

10. A method of organizing a business to align goals of the business with goals of customers of the business and accelerate value creation for both the business and the customers of the business, the method comprising:
identifying the experiences of customers of a business, wherein the experiences comprise the customers' value discovery experience, the customers' buying decision experience, the customers' ordering experience, the customers' receiving experience, the customers' using experience, the customers' payment experience, and the customers' feedback and problem resolution experience;
organizing the business under a process management system for one or more of the customer experiences identified, wherein each process management system comprises a process owner, a documenting process, formal process review, identification of customer driven measures and methods for process evaluation and improvement;
gathering customer feedback regarding one or more of the customer experiences; and
based on the customer feedback regarding one or more of the customer experiences, modifying the one or more process management systems associated with the customer experience to improve the one or more customer experiences,
wherein the step of gathering customer feedback comprises automatic or semiautomatic electronic communication from the customer to the business and where the feedback is retained in a database.

11. The method of claim 10 wherein the customer feedback is automatically or semi automatically communicated to a process management team.

12. The method of claim 11 wherein the process management team modifies the process management system.

13. A method of organizing a business in view of experiences of customers of said business comprising the steps of:
mapping at least one process within the business;
gathering customer feedback regarding one or more of the customer goals
based on said mapping of at least one process within the business, identifying why the process exists, where the process starts and stops, a sequence of steps in the process, customers of the process, and process outputs and inputs, mapping the at least one process within the business from a customer's point of view;
based on said mapping of the at least one process within the business from the customers point of view, identifying aspects of the at least one process that diverge from goals of the customer; and
based on said identifying aspects of the at least one process that diverge from goals of the customer, organize the at least one process within the business organization such that the process is more aligned with the goals of the customer or creates additional value for the customer.

14. The method of claim 13 wherein the step of gathering customer feedback regarding one or more of the customer goals is automated or semi-automated with an electronic system comprising a computer processor and at least one database.

15. The method of claim 14 wherein the step of mapping at least one process within the business comprises identification of customer goals.

16. The method of claim 15 further comprising the step of automatically communication the customer goals to a process management team automatically or semi automatically via electronic communication.
